(19) United States
(12) Patent Application Publication
(10) Pub. No.: US 2021/0003839 A1
(43) Pub. Date: Jan. 7, 2021

(54) DIFFRACTION DISPLAY SYSTEM

(71) Applicant: Jing JIANG, Beijing (CN)

(72) Inventor: Zhengyu HUANG, Beijing (CN)

(21) Appl. No.: 16/980,542

(22) PCT Filed: Feb. 21, 2019
(86) PCT No.: PCT/CN2019/075683

§ 371 Date: Sep. 14, 2020

(30) Foreign Application Priority Data
Mar. 14, 2018 (CN) 201810210017.8

(51) Int. Cl. G02B 26/08; G02B 27/42; G02B 27/01; G02B 26/10; B60K 35/00; B60J 1/02

(52) U.S. Cl. CPC G02B 26/0833; G02B 27/4205; G02B 27/0101; G02B 26/105; B60K 2370/785; B60J 1/02; B60K 2370/1529; B60K 2370/334; B60K 2370/66; B60K 35/00

(57) ABSTRACT

Disclosed is an anti-reflection diffraction display system, the system comprising: a substrate; a diffraction projection screen and an optical engine; the optical engine projects to the diffraction projection screen light carrying information of a target image, thereby displaying the target image by means of the diffraction of the diffraction projection screen, wherein the light emitted by the optical engine is not irradiated in a reflection window on the substrate, and the reflection window is a region on the substrate; and when the light emitted by the optical engine is irradiated to the region and reflected, the reflected light enters a design window of the diffraction display system. In addition, further disclosed are a directional projection-based diffraction display system that has a plurality of screens and a directional projection-based diffraction display system that has a whole screen.

### TECHNICAL FIELD

The present invention generally relates to a diffraction display system, and, in particular, to an anti-reflection diffraction display system, a directional projection-based multi-screen diffraction display system and a directional projection-based whole-screen diffraction display system.

### BACKGROUND

In a display system based on diffraction imaging, such as diffraction imaging-based augmented reality (AR) and mixed reality (MR) displays, and diffraction imaging-based vehicle-mounted head up display (HUD), light may not only be diffracted by diffractive devices, but also be reflected. If the reflected light enters a diffraction imaging window designed in the display system, it will cause interference to the diffraction imaging. When there is a transparent substrate having a certain thickness in the diffraction display system, the reflected light may form multiple virtual images, which are partially or completely superimposed with the diffracted image, resulting in more serious interference of the reflected light to the diffraction imaging. Therefore, in a display system based on diffraction imaging, it is an important optical design task to eliminate the influence of reflected light on the quality of diffraction imaging.

For example, one of the existing methods is to improve the diffraction efficiency of a diffraction display system. For example, an anti-reflection film is applied to make a diffracted image bright, and reduced reflection efficiency is also adopted. This method can greatly decrease the reflection energy and increase the contrast of the diffracted image. It is feasible to employ this method in display devices such as an augmented reality or mixed reality display, but the method, if being used in such applications as a vehicle-mounted head up display, will face the problems about a large area of the anti-reflection film, high costs for production of the same, poor wear resistance and aging. In addition, this method still cannot fundamentally solve the problem that reflected light beams will reduce the imaging contrast of the diffraction display system.

Accordingly, with the gradual promotion of different kinds of human-computer interfaces represented by augmented reality, mixed reality and vehicle-mounted head up displays, various augmented reality, mixed reality and vehicle-mounted head up displays based on the principle of diffraction imaging are also gradually emerging therefrom, and the technical demand for solving reflected light interference in a diffraction display system appears in the industry.

### SUMMARY

The present invention aims to provide diffraction display systems, which at least partially solves the aforesaid problems that exist in the prior art.

According to one aspect of the present invention, provided is an anti-reflection diffraction display system, the system comprising: a substrate; a diffraction projection screen, comprising a diffractive optical device arranged on at least one portion of the substrate; and an optical engine, comprising a coherent light source and an image modulator, and used to project to the diffraction projection screen light carrying information of a target image, thereby displaying the target image by means of the diffraction of the diffraction projection screen, wherein the diffraction display system has a design window, within the range of which a user can observe a virtual image of the target image displayed by the diffraction projection screen; the light emitted by the optical engine is not irradiated in a reflection window on the substrate, and the reflection window is a region on the substrate; and when the light emitted by the optical engine is irradiated to the region and reflected, the reflected light enters the design window of the diffraction display system.

In some embodiments, a last device surface of the optical engine constitutes the light emergent surface of the optical engine, and the reflection window is formed by the collection of intersection points between a line connecting any point of a desired reflection imaging position of the light emergent surface of the optical engine relative to the substrate to any point in the design window and the substrate.

Preferably, the optical engine is arranged in such a manner as to enable the reflection window to completely depart from the position of the diffraction projection screen.

The diffraction display system may be implemented as a HUD system mounted on a motor vehicle with the substrate as a windshield.

In some advantageous embodiments, the optical engine also includes a directional projection device arranged on an optical path of the optical engine and used for changing the divergence of light beams emitted from each point on the optical engine to make the same have a predetermined divergence angle, and/or changing the direction of a center ray of the light beams to enable the light beams to have a specific spatial angular distribution.

The directional projection device may be configured in such a manner as to enable the light emitted from the optical engine to be only irradiated within the range of the diffraction projection screen.

The directional projection device is a transmission-type device having a substantially plane-shaped substrate, and is configured in such a manner as to enable the center ray of the light beams emitted therefrom corresponding to each pixel to deviate from a direction perpendicular to the substrate.

In some advantageous embodiments, the image modulator modulates the light emitted by the coherent light source to obtain a light spatial distribution corresponding to the target image; the optical engine also includes a light diffusing device that receives the light from the coherent light source and forms an area light source to enable the light beams emitted from the optical engine corresponding to each pixel to be divergent; and the directional projection device is arranged downstream of the light diffusing device and upstream of the image modulator along the optical path of the optical engine, which limits the divergence angle of the light beams emitted from the optical engine corresponding to each pixel. In such embodiments, the directional projection device may include at least one of a lens, a diaphragm and a concave mirror.

In some advantageous embodiments, the image modulator modulates the light emitted by the coherent light source to obtain a light spatial distribution corresponding to the target image; the optical engine also includes a light diffusing device for diffusing the light to enable light beams emitted from the optical engine corresponding to each pixel to be divergent; and the directional projection device is arranged downstream of the optical diffusing device and the image modulator along the optical path of the optical engine, which limits a divergence angle of the light beams emitted from the optical engine corresponding to each pixel. In such embodiments, the light diffusing device may be arranged downstream of the image modulator along the optical path of the optical engine. The light diffusing device may also be integrated with the directional projection device. Alternatively, the light diffusing device may be arranged upstream of the image modulator along the optical path of the optical engine.

The directional projection device may include at least one of a diaphragm array, a micro prism array, a micro lens array, a grating, a CGH, a HOE and a DOE.

In some advantageous embodiments, the image modulator modulates the light emitted by the coherent light source to obtain a light spatial distribution corresponding to the target image; and the directional projection device receives and diffuses approximately parallel light beams corresponding to each pixel to enable the same to have a specific divergent spatial angular distribution. For example, the image modulator may include a scanning galvanometer. Preferably, the directional projection device may be a micro mirror array, a reflection-type grating or a reflection-type DOE arranged downstream of the scanning galvanometer along the optical path. The image modulator may be an LCD, an LCOS or a DMD, and the optical engine further includes a collimating beam expander arranged between the coherent light source and the image modulator.

The directional projection device may include at least one of a micro prism array, a micro lens array, a micro mirror array, a grating, a CGH, a HOE and a DOE.

In some advantageous embodiments, the diffraction projection screen diffracts the light from each pixel of the optical engine to form parallel or approximately parallel imaging beams, and the projection directions of the imaging beams corresponding to different pixels are different from each other.

According to another aspect of the present invention, provided is a diffraction display system based on directional projection, the system comprising: a substrate; at least two diffraction projection screens, each comprising diffractive optical devices arranged at different positions on the substrate; and a single optical engine, comprising a coherent light source and a single image modulator, and used for projecting to the diffraction projection screen light carrying information of a target image, thereby displaying a virtual image of the target image by means of the diffraction of the diffraction projection screen, wherein the single optical engine also includes a directional projection device arranged on an optical path of the optical engine and used for changing a direction of at least one portion of the light such that the target image corresponding to different diffraction projection screens is only projected onto the corresponding diffraction projection screen respectively.

Preferably, the diffraction display system has a design window, and the at least two diffraction projection screens both project light beams formed by the diffraction to the design window.

In some advantageous embodiments, the directional projection device has a substantially plane-shaped substrate, and is configured to have subregions in the same number as the diffraction projection screens, each of which has a different deflection effect on the direction of light irradiated thereon, so as to project the light to a corresponding diffraction projection screen. Preferably, the directional projection device may also be configured to limit a divergence angle of the light beams emitted from the optical engine corresponding to each pixel.

The directional projection device may include at least one of a diaphragm array, a micro mirror array, a micro prism array, a micro lens array, a grating, a CGH, a HOE and a DOE.

According to one more aspect of the present invention, provided is a diffraction display system based on directional projection, the system comprising: a substrate; a diffraction projection screen, comprising a diffractive optical device arranged on substantially the whole surface of the substrate; and an optical engine, comprising a coherent light source and an image modulator, and used for projecting to the diffraction projection screen light carrying information of a target image, thereby displaying the target image by means of the diffraction of the diffraction projection screen, wherein the optical engine also comprises a directional projection device arranged on an optical path of the optical engine to change the direction of the light such that light beams from each pixel corresponding to the target image are only projected onto a local region on the diffraction projection screen, and light beams corresponding to adjacent pixels are projected onto a region partially overlapped with each other on the diffraction projection screen, and the light beams corresponding to different pixels are projected onto different regions on the diffraction projection screen in pixel arrangement order.

In some embodiments, the maximum tension angle of the diffraction projection screen relative to the optical engine is greater than 120°.

In some advantageous embodiments, the diffraction projection screen diffracts the light from each pixel of the optical engine to form parallel or approximately parallel imaging beams, and the projection directions of the imaging beams corresponding to different pixels are different from each other.

The diffraction display system may be implemented as a HUD system mounted on a motor vehicle with the substrate as a windshield; in this case, it is preferred that the local region onto which the light beams emitted by the optical engine corresponding to each pixel of the target image are projected on the diffraction projection screen has an area greater than 10 cm×10 cm.

Preferably, the directional projection device may also limit a divergence angle of the light beams emitted from the optical engine corresponding to each pixel.

In some advantageous embodiments, the directional projection device is a transmission-type device having a substantially plane-shaped substrate, and is configured in such a manner as to enable a center ray of the light beams emitted therefrom to deviate from a direction perpendicular to the substrate.

The directional projection device may include at least one of a diaphragm array, a micro mirror array, a micro prism array, a micro lens array, a grating, a CGH, a HOE, and a DOE.

### BRIEF DESCRIPTION OF THE DRAWINGS

Other features, purposes and advantages of the present invention will be more apparent by reading the detailed description of the non-limitative embodiments with reference to the following drawings:

FIG. 1 is a schematic diagram of a diffraction display system to which the techniques of the present invention may be applied;

FIG. 2 illustrates the reflection problems that exist in the diffraction display system shown in FIG. 1;

FIG. 3 illustrates a reflection window corresponding to a pixel on the optical engine;

FIG. 4 illustrates a reflection window corresponding to the whole optical engine;

FIG. 5 shows a possible position where a light barrier for solving the reflection problem may be arranged;

FIG. 6 is a principle diagram of an anti-reflection diffraction display system according to one embodiment of the present invention;

FIG. 7 is a structural diagram of an anti-reflection diffraction display system according to one embodiment of the present invention;

FIG. 8 is a schematic diagram of a first embodiment of an optical engine that may be used in a diffraction display system according to one embodiment of the present invention;

FIG. 9 is a schematic diagram of a second embodiment of an optical engine that may be used in a diffraction display system according to one embodiment of the present invention;

FIGS. 10A, 10B, 10C and 10D show examples of a transmission-type directional projection device;

FIG. 11 shows an example of an anti-reflection diffraction display system according to one embodiment of the present invention, which is equipped with a reflection-type directional projection device;

FIGS. 12A and 12B schematically show examples of a reflection-type directional projection device;

FIG. 13 is a schematic diagram of a third embodiment of an optical engine that may be used in a diffraction display system according to one embodiment of the present invention;

FIG. 14 is a schematic diagram of a fourth embodiment of an optical engine that may be used in a diffraction display system according to one embodiment of the present invention;

FIG. 15 is a schematic diagram of a fifth embodiment of an optical engine that may be used in a diffraction display system according to one embodiment of the present invention;

FIG. 16 shows an example of an anti-reflection diffraction display system equipped with the optical engine shown in FIG. 15;

FIG. 17 and FIG. 18 schematically show a directional projection-based diffraction display system having a plurality of screens according to one embodiment of the present invention; and

FIG. 19 and FIG. 20 schematically show a directional projection-based diffraction display system having a whole screen on according to one embodiment of the present invention.

### DETAILED DESCRIPTION

The present invention will be further described below in detail with reference to the drawings and embodiments. It may be understood that the specific embodiments set forth herein are only used to explain the related inventions, instead of making limitations of the same. In addition, it should be noted that only parts related to invention are shown in the drawings for the convenience of description.

It should be noted that the embodiments of the present application and the features therein can be combined with each other in case of no conflicting. The present invention will be explained below in detail with reference to the drawings together with the embodiments.

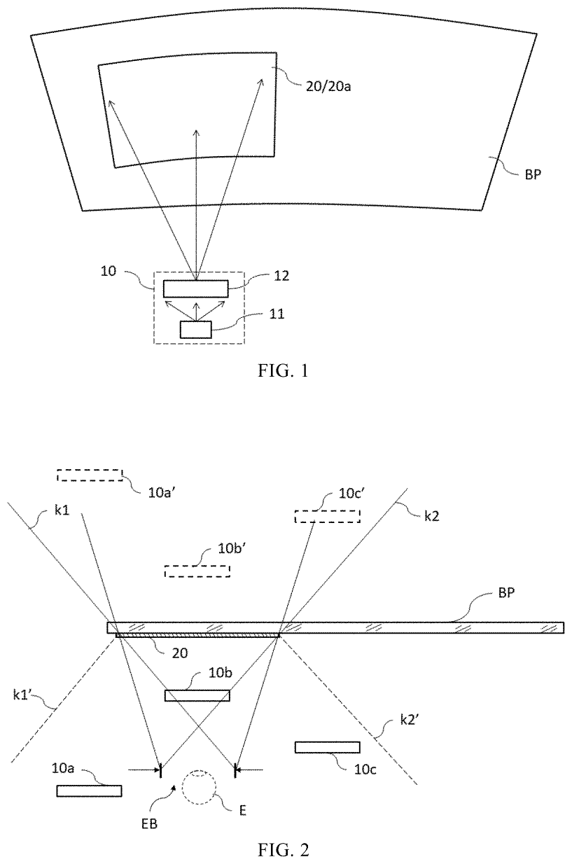

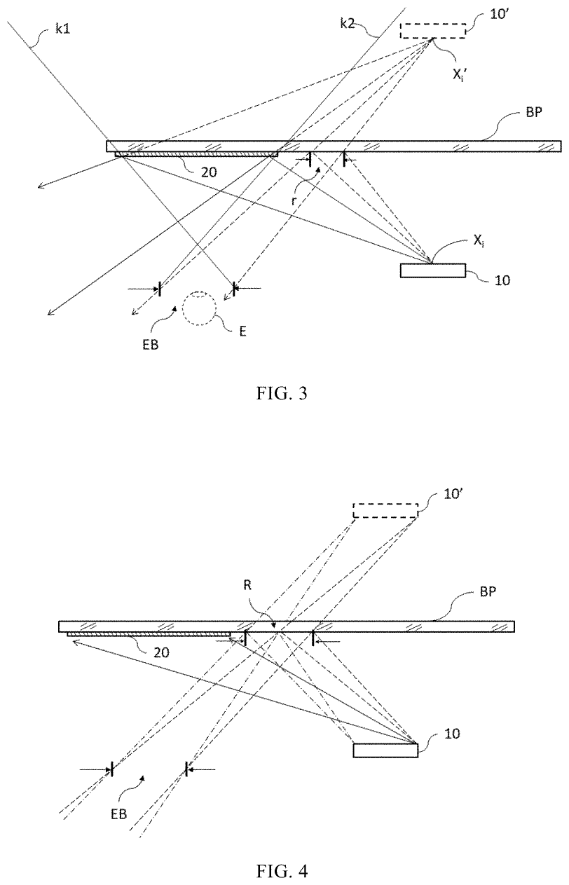

FIG. 1 is a schematic diagram of a diffraction display system to which the techniques of the present invention may be applied. As shown in the figure, the diffraction display system comprises a substrate BP, an optical engine 10 and a diffraction projection screen 20. The diffraction projection screen 20 includes a diffractive optical device 20a arranged on at least one portion of the substrate BP. The optical engine 10 includes a coherent light source 11 and an image modulator 12, which is used to project to the diffraction projection screen 20 light carrying information of a target image, thereby displaying the target image by means of the diffraction of the diffraction projection screen 20. The diffraction display system has a design window EB (see FIG. 2), within the range of which a user can observe a virtual image of the target image displayed by the diffraction projection screen 20

The diffraction display system shown in FIG. 1 may be implemented as, for example, a HUD system of a motor vehicle (e.g., a vehicle or an aircraft), in which, for example, the substrate BP is composed of a windshield, and the optical engine 10 may be mounted or integrated at, for example, the top of the dashboard or other positions.

One problem with such a diffraction display system is that light emitted by the optical engine 10 not only displays the target image by means of the diffraction of the diffraction projection screen 20, but also may be reflected by the surface of the substrate BP (including the surface of the diffraction projection screen 20) to form an virtual image of the optical engine. If the virtual image formed by the reflection falls within the field of view of the design window EB of the diffraction display system, this will cause great interference for a user of the diffraction display system, especially when the optical engine 10 provides light having high brightness.

As shown in FIG. 2, lines k1 and k2 indicate a field of view that an eye E within the design window EB can observe through the diffraction projection screen 20; while lines k1′ and k2′ are formed by the lines k1 and k2 mirrored with respect to the reflecting surface of the substrate BP; and when the optical engines 10a, 10b and 10c are within the range between the lines k1 ‘and k2’, virtual images 10a′, 10b′ and 10c′ formed by the reflection of the optical engines 10a, 10b and 10c by the surface of the substrate BP are approximately located within the range between the lines k1 and k2 (the substrate BP may have a certain radian, which may affect the positions of the virtual images), and accordingly are within the field of view of the design window EB, thereby resulting in the visual interference.

Even if the optical engine 10 is disposed beyond the range between the lines k1′ and k2′ shown in FIG. 2, a corresponding reflection window may still be formed in a region, other than the diffraction projection screen 20, on the substrate BP. When the light emitted by the optical engine 10 is irradiated to the region and reflected, the reflected light enters the design window EB of the diffraction display system. For ease of understanding, first of all, FIG. 2 shows that a reflection window r is formed on the substrate BP by a point (e.g., a pixel Xi) on the light emergent surface of the optical engine 10 relative to the design window EB. As shown in FIG. 2, the optical engine 10 forms a virtual image 10′ by means of the reflection on the surface of the substrate BP, and points of intersection between a line connecting a point Xi′ on the virtual image 10′ corresponding to the pixel Xi on the optical engine 10 to any point in the design window EB (only lines connected with the boundaries of the design window EB are shown in the figure) and the substrate BP are collected to form on the substrate the reflection window r of the point on the light emergent surface relative to the design window EB. Similarly, in consideration of all the points on the light emergent surface of the optical engine 10, a reflection window R of the whole optical engine 10 relative to the design window EB is obtained on the substrate BP as shown in FIG. 3, the reflection window R is formed by means of the collection of intersection points between a line connecting any point of a desired reflection imaging position (denoted by dotted lines) of the light emergent surface of the optical engine 10 relative to the substrate BP to any point in the design window EB and the substrate BP. The surface of the last device of the optical engine 10 constitutes the light emergent surface of the optical engine.

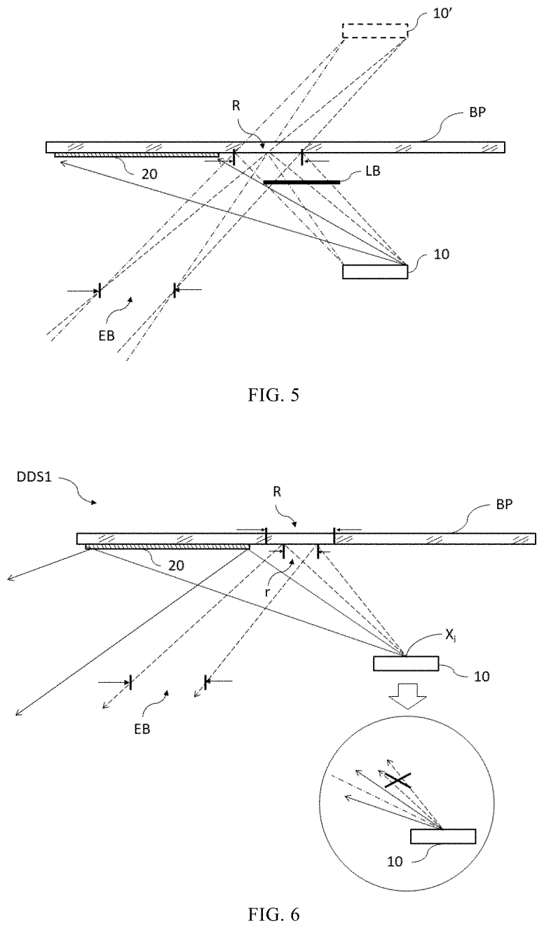

In order to solve the aforesaid problem about visual interference caused by reflection, a light barrier may be disposed as shown in FIG. 5. However, in order not to block the light projected by the optical engine 10 to the diffraction projection screen 10, and in order to fully block the light projected to the reflection window R at the same time, the light barrier may have a substantial size and be arranged at a position adjacent to the substrate BP (e.g. a windshield), for example, at the position between the light barrier LB and the reflection window R shown in FIG. 5. Therefore, this is not a satisfactory solution.

According to one embodiment of the present invention, an anti-reflection diffraction display system is provided on the basis of the diffraction display system shown in FIG. 1, where the diffraction display system shown in FIG. 1 is further configured in such a manner that the light emitted by the optical engine 10 is not irradiated into the reflection window R on the substrate BP. In this way, the light emitted by the optical engine 10 may not enter the design window EB of the diffraction display system due to the reflection of the reflection window R, thus avoiding visual interference.

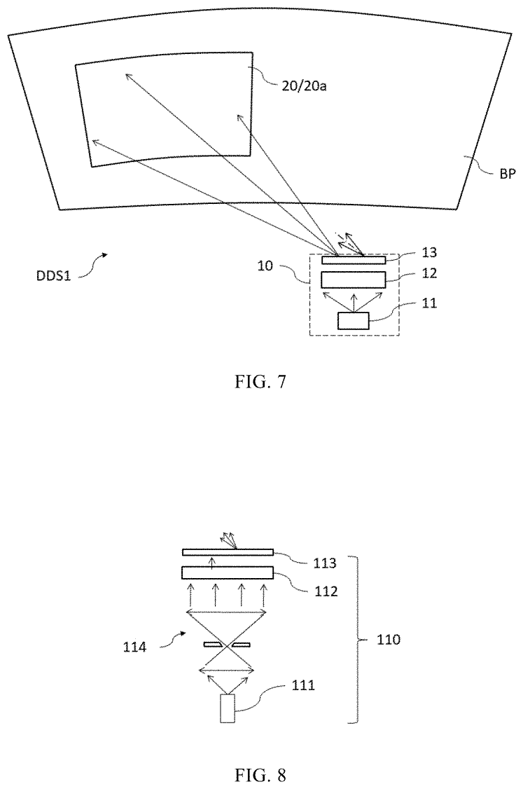

FIGS. 6 and 7 show the schematic diagram and structural diagram of an anti-reflection diffraction display system DDS1 according to the embodiment of the present invention respectively. As shown in FIG. 6, in the anti-reflection diffraction display system according to one embodiment of the present invention, the optical engine is arranged in such a position as to enable the reflection window R to completely depart from the position of the diffraction projection screen. As shown in FIG. 7, the optical engine 10 may further include a directional projection device 13 arranged on an optical path of the optical engine 10. The directional projection device 13 changes the divergence of light beams emitted from points on the optical engine 10 to make the same have a predetermined divergence angle, and/or changes the direction of a center ray of the light beams to enable the light beams to have a specific spatial angular distribution, thereby preventing the light emitted from the optical engine 10 being irradiated into the reflection window R, as shown in FIG. 6. Preferably, the directional projection device 13 is configured in such a manner as to enable the light emitted from the optical engine 10 to be only irradiated within the range of the diffraction projection screen 20.

In the anti-reflection diffraction display system according to one embodiment of the present invention, the diffraction projection screen 20 may be directly formed on the substrate BP, or may be formed independently and then attached onto the surface of the substrate or, for example, sandwiched between possibly more than one layer of the substrate.

In some embodiments, in order to form a distant and magnified virtual image of the target image to make it easy for users of the diffraction display system to view the image, the diffraction projection screen 20 can diffract light corresponding to each pixel from the optical engine 10 to form parallel or approximately parallel imaging beams, and the projection directions of the imaging beams corresponding to different pixels are different from each other. In this way, due to the effect of the passage of the light beams corresponding to each pixel from the optical engine through the user's eyeball E, a corresponding image point can be formed on the retina, and different pixels form image points at different positions of the human eye's retina, such that the user can observe the magnified virtual image at or near infinity. However, it should be understood that the diffraction display system according to the present invention does not depend on the aforesaid working mode of the diffraction projection screen 20 to achieve anti-reflection, so the present invention is not limited in this aspect.

The diffractive optical device used in the present invention may comprise at least one of a holographic film, a computer-generated hologram (CGH), a holographic optical element (HOE) and a diffractive optical element (DOE). By taking a holographic film as an example, it may be formed by, for example, the coherence of the object light as a plane wave and the reference light as a spherical wave. In order to achieve a better display effect, exposure can also be made by adopting the method of moving the light source point of the reference light/using the light source points of multiple reference light. In addition, for example, the hologram can also be generated by computer, processed into a motherboard by means of electron beam/etching, and then a diffractive optical device with the hologram can be produced by coining.

Though not shown in the drawings, the diffractive optical device 20a may have multiple diffractive layers used for different wavelengths respectively, and may also have a monolayered structure for different wavelengths, or a combination of a layered structure for a single wavelength and a layered structure for two or more wavelengths.

The coherent light source 11 is preferably a laser light source, or may also be a white light source with a narrow-band filter, for example. In consideration of the use of the diffraction display system in different ambient light conditions such as day and night, the coherent light source 11 may also be formed switchable between more than one light source. In addition, the coherent light source 11 can provide monochromatic coherent light, and can also provide polychromatic coherent light, such as the trichromatic light including red, green and blue light.

The image modulator 12 can, for example, modulate light emitted by the coherent light source to obtain a light spatial distribution corresponding to the target image. In some embodiments, the image modulator 12 may be formed using a spatial light modulator (SLM), which includes, for example, an LCD, an LCOS, a DMD, etc. In other embodiments, the image modulator 12 may, for example, include a scanning galvanometer, such as a scanning galvanometer based on a micro electro mechanical system (MEMS).

Although FIG. 7 shows that the directional projection device 13 is arranged downstream of the image modulator 12 in the optical path of the optical engine 10, this is not restrictive, but illustrative only. In addition, other optical devices may be included in the optical engine 10. Different embodiments of an optical engine that may be used in an anti-reflection diffraction display system according to the embodiments of the present invention will be described below with reference to drawings.

FIG. 8 is a schematic diagram of a first embodiment of an optical engine that may be used in a diffraction display system according to one embodiment of the present invention. As shown in FIG. 8, the optical engine 110 according to the first embodiment includes a coherent light source 111, an image modulator 112 and a directional projection device 113 arranged in turn along an optical path. The optical engine 110 may also include a beam expander 114 arranged between the coherent light source 111 and the image modulator 112, and used for expanding light from the coherent light source 111 to illuminate the whole surface of the image modulator 112. Preferably, the beam expander 114 also collimates the light. The light with good directivity emitted from each pixel of the image modulator 112 is irradiated onto the directional projection device 113 which, for example, enables the light beams corresponding to each pixel to have a predetermined divergence angle and changes the direction of a center ray of the light beams such that the light emitted by the optical engine can be projected to an appropriate region on the diffraction projection screen without entering the reflection window R.

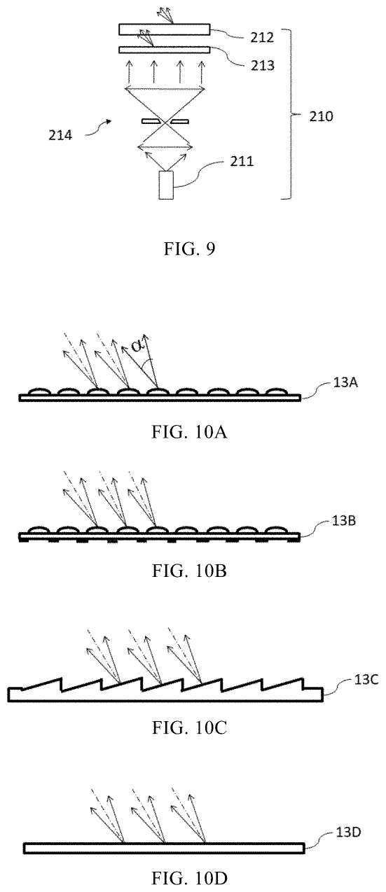

FIG. 9 is a schematic diagram of an optical engine 210 according to a second embodiment. The optical engine 210 is substantially the same in configuration as the optical engine 110 according to the first embodiment, and the only difference between both lies in that a directional projection device 213 in the optical engine 210 is arranged upstream of an image modulator 212 along an optical path. Light from a coherent light source 211 is irradiated onto the directional projection device 213 after being expanded and collimated by an optional beam expander 214; the directional projection device 213 enables the light emitted therefrom to have a predetermined divergence angle and changes the direction of a center ray of light beams, thereby forming a specific light spatial angular distribution; and light emitted from the image modulator 212 maintains the predetermined divergence angle and the direction of the center ray of the light beams formed by the directional projection device 213 such that the light emitted by the optical engine can be projected to an appropriate region on the diffraction projection screen without entering the reflection window R.

FIGS. 10A to 10D show examples of a transmission-type directional projection device that may be used in a diffraction display system according to one embodiment of the present invention. As shown in the figures, the directional projection device may be configured in such a manner that light beams emitted therefrom (e.g., corresponding to each pixel), upon transmission and/or refraction, have a predetermined divergence angle, and the direction of a center ray of the light beams is changed, thereby forming specific spatial angular distribution. Preferably, the directional projection device may be a transmission-type device having a substantially plane-shaped substrate, and is configured in such a manner as to enable the center ray of the light beams emitted therefrom corresponding to each pixel to deviate from a direction perpendicular to the substrate. In the example shown in FIG. 10A, the directional projection device 13A is composed of a micro lens array; in the example shown in FIG. 10B, the directional projection device 13B is composed of a combination of a micro lens array and a diaphragm array; in the example shown in FIG. 10C, the directional projection device 13C is composed of a micro prism array; and in the example shown in FIG. 10D, the directional projection device 13D is composed of such diffractive devices as HOE, CGH, DOE, etc. It should be understood that FIG. 10 is illustrative only, and a transmission-type directional projection device applicable to the present invention is not limited to the above configurations, but may include, for example, a diaphragm array, a micro prism array, a micro lens array, a grating, a HOE, a CGH, a DOE or any other suitable device, or a combination thereof.

Although the image modulators 112, 212 in the optical engines shown in FIGS. 8 and 9 are shown as a transmission type, the present invention is not limited to this case, and the image modulators 112, 212 may also be reflection-type. Similarly, although the directional projection devices 113, 213 in FIGS. 8 and 9 are shown as a transmission type, the present invention is not limited to this case, and the directional projection devices 113, 213 may also be reflection-type.

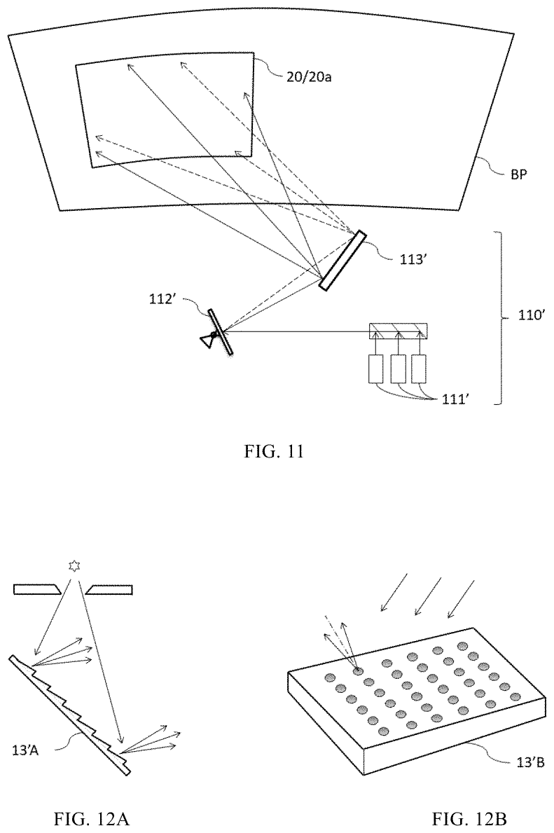

FIG. 11 shows an example of an anti-reflection diffraction display system according to one embodiment of the present invention, which is equipped with a reflection-type directional projection device and a reflection-type image modulator. In the example shown in FIG. 11, the diffraction display system comprises a substrate BP, an optical engine 110′, and a diffraction projection screen 20. The image modulator in the optical engine 110′ includes a scanning galvanometer, and a directional projection device 113′ arranged in an optical path downstream of the scanning galvanometer is adopted.

According to the present embodiment, the image modulator includes a scanning galvanometer 112′, and may also include a light source modulator (not shown in the figure) combined in, for example, a coherent light source 111′, the light source modulator modulates light output by the coherent light source 111′, including, for example, the intensity of the light and/or the wavelength (color) of the light, in a time sequence.

Light output from the coherent light source 111′ and modulated in respect of, for example, light intensity/color in a time sequence is illuminated onto the scanning galvanometer 112′, and the scanning galvanometer 112′ reflects the light at different angles corresponding to the time sequence of the light source modulation, so as to form a light spatial distribution corresponding to the target image. The light output from the scanning galvanometer 112′ and having the light spatial distribution corresponding to the target image is illuminated onto the directional projection device 113′, and then the directional projection device 113′ enables, by means of reflection, light beams emitted therefrom (e.g., corresponding to each pixel) to have a predetermined divergence angle and changes the direction of a center ray of the light beams so as to have a specific spatial angular distribution, such that the light emitted by the optical engine can be projected to an appropriate region on the diffraction projection screen without entering the reflection window R. The light with a specific spatial angular distribution is projected to the diffraction projection screen 20, and forms a magnified virtual image of the target image upon the diffraction effect of the diffraction projection screen 20.

It should be understood that a reflection-type image modulator may be used in combination with a transmission-type directional projection device, and a transmission-type image modulator may also be used in combination with a reflection-type directional projection device. Based on the above explanation, those skilled in the art can combine different image modulators and directional projection devices according to needs, and the present invention is not limited in this aspect.

FIGS. 12A and 12B show examples of a reflection-type directional projection devices that may be used in a diffraction display system according to one embodiment of the present invention. As shown in the figures, a directional projection device may be configured in such a manner as to enable, by means of reflection, light beams emitted therefrom (e.g., corresponding to each pixel) to have a predetermined divergence angle and change the direction of a center ray of the light beams so as to have a specific spatial angular distribution. FIG. 12A shows a directional projection device 13′A composed of, for example, a grating; and FIG. 12B shows a directional projection device 13′B composed of, for example, a micro mirror array which may include micro convex mirrors or micro concave mirrors. Certainly, what is shown in FIG. 12 is not restrictive, but illustrative only. For example, a reflection-type directional projection device may also be composed of a HOE, a CGH, a DOE or other diffracting devices. In addition, for example, a directional transmission device may also be combined with a diaphragm array so as to better achieve directional projection.

In addition, according to the present invention, both the transmission-type directional projection device shown in FIG. 10 and the reflection-type directional projection device shown in FIG. 12 can be further configured in such a manner that different pixels corresponding to the target image or on the image modulator can form different spatial angular distributions of light, that is, can have different divergence angles and/or have different directions of a center ray of the light beams. This may be achieved by, for example, changing parameters (e.g., aperture diameter, focal length) and/or arrangement period of unit devices (e.g., micro lens, diaphragm, micro mirror) in an array (e.g., micro lens array, diaphragm array, micro mirror array). As for a directional projection device composed of a HOE, a CGH, a DOE or other diffracting devices, this can be achieved by calculation and hologram processing based on the calculation.

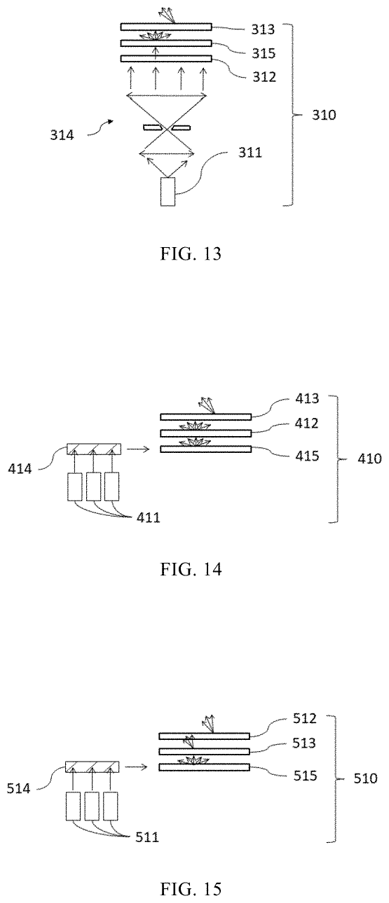

Next, a third, fourth and fifth embodiments of an optical engine that may be used in a diffraction display system according to one embodiment of the present invention will be described with reference to FIGS. 13, 14 and 15. In these embodiments, the optical engine further includes a light diffusing device for diffusing light to enable light beams emitted from the optical engine and corresponding to each pixel to be divergent; and the directional projection device is arranged downstream of the light diffusing device along the optical path of the optical engine, which limits a divergence angle of the light beams emitted from the optical engine and corresponding to each pixel to the predetermined divergence angle.

In the third embodiment shown in FIG. 13, an optical engine 310 includes a coherent light source 311, an image modulator 312, a light diffusing device 315, and a directional projection device 313 arranged in turn along an optical path. The optical engine 310 may also include a beam expander 314 arranged between the coherent light source 311 and the image modulator 312 and used for expanding light from the coherent light source 311. Preferably, the beam expander 314 also collimates the light. The light with good directivity emitted from pixels of the image modulator 312 is irradiated onto the light diffusing device 315, and forms, upon the diffraction of the light diffusing device 315, light beams having a divergent spatial angular distribution corresponding to each pixel. As shown in FIG. 13, the light beams formed by the light diffusing device 315 may have an excessively divergent spatial angular distribution and/or an inappropriate beam direction (which may be represented by the direction of a center ray of the light beams) such that the beams will be projected into the reflection window R on the substrate BP. The directional projection device 313 arranged downstream of the light diffusing device 315 limits, by means of its effect on the light beams, the divergence angle of the light beams corresponding to each pixel to a predetermined divergence angle, and can also change the direction of a center ray of the light beams, such that the light emitted by the optical engine can be projected to an appropriate region on the diffraction projection screen without entering the reflection window R.

FIG. 14 shows a fourth embodiment of an optical engine. As shown in FIG. 14, an optical engine 410 includes a coherent light source 411, an optical diffusing device 415, an image modulator 412, and a directional projection device 413 arranged in turn along an optical path. The optical engine 410 according to the fourth embodiment and the optical engine 310 according to the third embodiment are constructed in substantially the same manner, and the major difference between both lies in that the light diffusing device 315 in the optical engine 310 is arranged downstream of the image modulator 312, while the optical diffusing device 415 in the optical engine 410 is arranged upstream of the image modulator 412.

As shown in FIG. 14, the optical engine 410 may also include a beam combiner 414 for combining light from the coherent light source 411, such as light from laser devices having different wavelengths, into a beam of light to facilitate transmission to the optical diffusing device 415. In the example shown in FIG. 14, the light diffusing device 415 may be composed of a light guide plate, for example. In some examples where the image modulator 412 adopts an LCD, the coherent light source 411 may also be integrated with the optical diffusing device 415 to form a backlight assembly.

Light from the coherent light source 411 is diffused by the optical diffusing device 415 and modulated by the image modulator 412 to form light beams with a divergent spatial angular distribution corresponding to each pixel; and then, by the effect of the directional projection device 413, the divergence angle of the light beams corresponding to each pixel is limited to a predetermined divergence angle, and the direction of a center ray of the light beams can be changed such that the light emitted by the optical engine can be projected to an appropriate region on the diffraction projection screen without entering the reflection window R.

FIG. 15 shows a fifth embodiment of an optical engine. As shown in FIG. 15, an optical engine 510 includes a coherent light source 511, a light diffusing device 515, a directional projection device 513, and an image modulator 512 arranged in turn along an optical path. The optical engine 510 according to the fifth embodiment and the optical engine 410 according to the fourth embodiment are configured in substantially the same manner, and the major difference between both lies in that the directional projection device 413 in the optical engine 410 is arranged downstream of the image modulator 412, while the directional projection device 513 in the optical engine 510 is arranged upstream of the image modulator 512.

Light from the coherent light source 511 is diffused by the optical diffusing device 515 to form the light with a divergent spatial angular distribution; then, by the effect of the directional projection device 513, the divergence angle of the light beams corresponding to each pixel is limited to a predetermined divergence angle, and the direction of a center ray of the light beams can be changed to obtain the light beams with a specific spatial angular distribution; and the light emitted from the image modulator 512 maintains the predetermined divergence angle and the direction of the center ray of the light beams formed by the directional projection device 513 such that the light emitted by the optical engine can be projected to an appropriate region on the diffraction projection screen without entering the reflection window R.

In regard to the third and fifth embodiments of an optical engine shown in FIGS. 13 and 15, the light diffusing device may be integrated with the directional projection device in some preferred examples. In regard to the fourth embodiment of an optical engine shown in FIG. 14, the directional projection device may be integrated on the surface of the image modulator in some preferred examples.

As discussed above with reference to FIG. 10 and FIG. 12, the directional projection devices 313, 413, 513 may include a diaphragm array, a micro prism array, a micro lens array, a micro mirror, a grating, a CGH, a HOE, a DOE or any other suitable device, or a combination thereof.

In addition, similar to the discussion made above on the embodiments shown in FIG. 8 and FIG. 9, although the image modulators, optical diffusing devices and directional projection devices in the optical engines shown in FIGS. 13-15 are provided in a transmission type, the present invention is not limited to this case since these illustrations are exemplary only. Therefore, the above devices may also be reflection-type respectively.

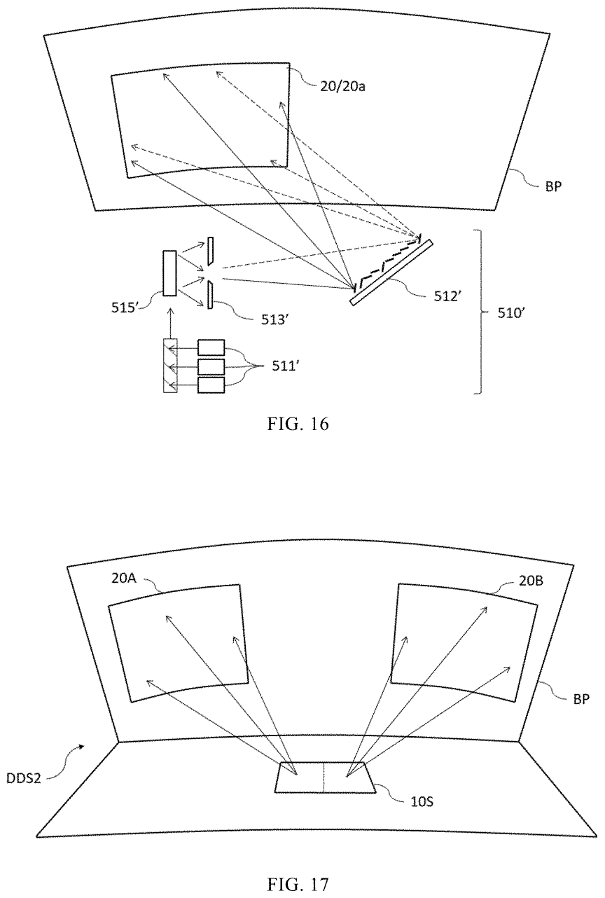

For example, FIG. 16 shows an example of an anti-reflection diffraction display system equipped with the optical engine shown in FIG. 15, in which a reflection-type DMD is used as an image modulator in an optical engine 510′.

Specifically, in the example shown in FIG. 16, the diffraction display system comprises a substrate BP, an optical engine 510′, and a diffraction projection screen 20. The optical engine 510′ includes a coherent light source 511′, an optical diffusing device 515′, a directional projection device 513′ and an image modulator 512′ arranged in turn along an optical path. Among them, the optical diffusing device 515′ is in the form of a light guide plate, the directional projection device 513′ is formed using a diaphragm, and the image modulator 512′ is formed using a DMD. The optical diffusing device 515′ receives light from the coherent light source 511′ and forms an area light source to enable the emitted light beams to be divergent. The directional projection device 513′ in the form of a diaphragm is arranged downstream of the optical diffusing device 515 and upstream of the image modulator 512′, which limits the divergence angle of the light beams corresponding to each pixel and reflected on the micro mirror surface of the DMD as an image modulator, such that the light emitted by the optical engine 510′ can be projected to an appropriate region on the diffraction projection screen 20 without entering the reflection window R.

As an alternative, the directional projection device 513′ may also be formed using a lens, a concave mirror or any other suitable device.

The anti-reflection diffraction display system according to one embodiment of the present invention is described above with reference to the drawings, and the optical engines, especially the directional projection devices therein, which may be used in the diffraction display system are also described with reference to the drawings and the embodiments.

According to other embodiments of the present invention, based on a concept of directional projection similar to the directional projection described above, a diffraction display system having a plurality of screens and a diffraction display system having a whole screen are also provided herein. Both will be described more specifically below with reference to the drawings.

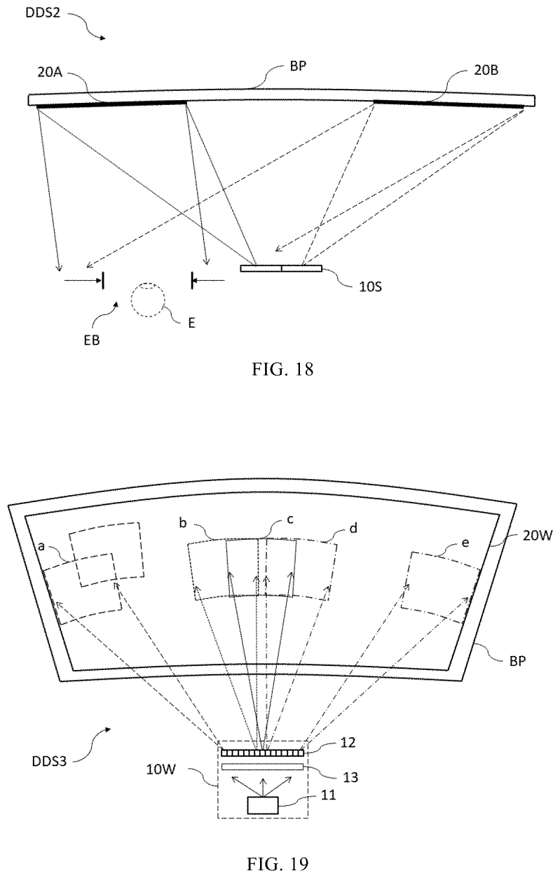

FIG. 17 and FIG. 18 schematically show a directional projection-based diffraction display system DDS2 having a plurality of screens according to one embodiment of the present invention.

As shown in FIG. 17 and FIG. 18, the diffraction display system DDS2 comprises a substrate BP, at least two diffraction projection screens 20A and 20B, and a single optical engine 10S. In the example shown in the figures, explanation will be made only using two diffraction projection screens as an example, but the present invention is not limited to this case. The two diffraction projection screens 20A and 20B each include diffractive optical devices arranged at different positions on the substrate. The diffractive optical devices may be, for example, the diffractive optical devices described above together with the diffraction display system DDS1, which will not be described any more here.

The single optical engine 10S includes a coherent light source and a single image modulator (not shown), for projecting to the diffraction projection screens 20A and 20B light carrying information of a target image, thereby displaying a virtual image of the target image by means of the diffraction of the diffraction projection screens. The single optical engine 10S also includes a directional projection device (not shown) arranged on the optical path of the optical engine and used for changing the direction of at least one portion of the light. In addition, the optical engine 10S in the diffraction display system DDS2 may also comprise a light diffusing device.

In the diffraction display system DDS2, the single optical engine 10S and various devices included therein, such as a coherent light source, an image modulator, a directional projection device and a light diffusing device, may have a configuration the same as or similar to the optical engine 10 or the corresponding devices described above together with the diffraction display system DDS1. The major difference between both lies in that the directional projection device in the single optical engine 10S in the diffraction display system DDS2 changes the direction of at least one portion of light such that the light of the target image corresponding to different diffraction projection screens is projected only to the corresponding diffraction projection screens respectively. This can be achieved by, for example, using different directional projection devices corresponding to different display subregions of the image modulator, or applying a directional projection device only to one display subregion of the image modulator. As an example, the directional projection device may have a substantially plane-shaped substrate, and is configured to have subregions in the same number as the diffraction projection screens, each of the subregions has a different deflection effect on the direction of light irradiated thereon, so as to project the light to a corresponding diffraction projection screen.

On this basis, the directional projection device in the single optical engine 10S of the diffraction display system DDS2 may be further configured to change the divergence of light beams emitted from each point on the optical engine to make the same have a predetermined divergence angle so as to enable the light beams to have a specific spatial angular distribution.

It can be understood that, similar to the directional projection device in the diffraction display system DDS1, the directional projection device in the diffraction display system DDS2 may also include at least one of a diaphragm array, a micro mirror array, a micro prism array, a micro lens array, a grating, a CGH, a HOE and a DOE, though not shown.

FIG. 18 shows more clearly one preferred example of a diffraction display system DDS2. In the example shown in FIG. 18, each of the diffraction projection screens 20A and 20B diffracts light from a pixel of the optical engine 10S to form parallel or approximately parallel imaging beams, and the projection directions of the imaging beams corresponding to different pixels are different from each other. The diffraction display system DDS2 has a design window EB, to which the diffraction projection screens 20A and 20B project the imaging beams so that a user in the design window EB can observe the target image projected and displayed by each diffraction projection screen.

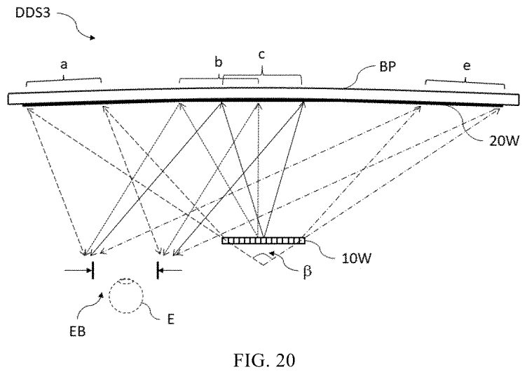

Next, a directional projection-based diffraction display system DDS3 having a whole screen according to one embodiment of the present invention will be described with reference to FIG. 19 and FIG. 20.

As shown in FIG. 19 and FIG. 20, the diffraction display system DDS3 comprises a substrate BP, a diffraction projection screen 20W and an optical engine 10W.

The diffraction projection screen 20W includes a diffractive optical device arranged on a substantially entire surface of the substrate BP. The diffractive optical device may be, for example, the diffractive optical device described above together with the diffraction display system DDS1, which will not be described any more here. In some examples, the maximum field angle β of the diffraction projection screen 20W relative to the optical engine 10W is greater than 120°.

The optical engine 10W includes a coherent light source 11 and an image modulator 12, for projecting to the diffraction projection screen light carrying information of a target image, thereby projecting and displaying the target image by means of the diffraction of the diffraction projection screen 20W. The optical engine 10W also includes a directional projection device 13 arranged on an optical path of the optical engine and used for changing the direction of light. It should be understood that the sequence of arranging the coherent light source 11, the image modulator and the directional projection device 13 along the optical path shown in FIG. 19 is not restrictive, but illustrative only. In some embodiments, the optical engine 10W in the diffraction display system DDS3 may also include a light diffusing device.

In the diffraction display system DDS3, the optical engine 10W and various devices included therein, such as a coherent light source, an image modulator, a directional projection device and a light diffusion device, may have a configuration the same as or similar to the optical engine 10 or the corresponding devices described above together with the diffraction display system DDS1. The major difference between both lies in that the directional projection device in the optical engine 10W in the diffraction display system DDS3 changes the direction of the light such that light beams corresponding to each pixel of the target image are only projected onto a local region (such as regions a, b, c, d, e . . . shown in FIG. 19) on the diffraction projection screen, and light beams corresponding to adjacent pixels are projected onto regions partially overlapped with each other (such as regions b, c, d shown in FIG. 19) on the diffraction projection screen, and the light beams corresponding to different pixels are projected onto different regions (such as regions a, b, c, d, e) on the diffraction projection screen in the arrangement order of the pixels. For example, each unit element in the directional projection device in the array form may be designed corresponding to each pixel of the image modulator, and they may have different parameters or varying mutual position relations respectively, so as to achieve the aforesaid projection effect corresponding to different pixels.

On this basis, the directional projection device in the optical engine 10W in the diffraction display system DDS3 may be further configured to change the divergence of light beams emitted from each point on the optical engine to make the same have a predetermined divergence angle so as to enable the light beams to have a specific spatial angular distribution.

The diffraction display system DDS3 may be implemented as a HUD system mounted on a motor vehicle, in which the substrate BP is composed of a windshield. In this case, the local regions a, b, c, d, e . . . onto which the light beams emitted by the optical engine 10W and corresponding to each pixel of the target image are projected on the diffraction projection screen 20W each have an area greater than 10 cm×10 cm.

It can be understood that, similar to the directional projection devices in the diffraction display systems DDS1 and DDS2, the directional projection device in the diffraction display system DDS3 may also include at least one of a diaphragm array, a micro mirror array, a micro prism array, a micro lens array, a grating, a CGH, a HOE and a DOE, though not shown.

FIG. 20 shows more clearly one preferred example of a diffraction display system DDS3. In the example shown in FIG. 20, the diffraction projection screen 20W diffracts light from each pixel of the optical engine 10W to form parallel or approximately parallel imaging beams, and the projection directions of the imaging beams corresponding to different pixels are different from each other. The diffraction display system DDS3 has a design window EB, to which the imaging beams are all projected so that a user can observe in the design window EB the target image projected and displayed by respective diffraction projection screen.

Described above are only the better embodiments of the present application and an explanation of the adopted technical principles. Those skilled in the art should understand that the invention scope referred to in the present application is not limited to the technical solutions formed by the specific combination of the above technical features, but also should cover other technical solutions concluded by the arbitrary combination of the aforesaid technical features or the equivalents without departing from the inventive concept, for example, the technical solutions reached by means of replacing the aforesaid features with the technical features having similar functions disclosed in the present application (but not limited to so).

1. An anti-reflection diffraction display system, comprising:
a substrate;
a diffraction projection screen comprising a diffractive optical device arranged on at least one portion of the substrate; and
an optical engine, comprising a coherent light source and an image modulator, and used to project to the diffraction projection screen light that carries information of a target image, thereby displaying the target image by the diffraction of the diffraction projection screen,
wherein the diffraction display system has a design window, within the range of which a user can observe a virtual image of the target image displayed by the diffraction projection screen; and
wherein the light emitted by the optical engine is not irradiated in a reflection window on the substrate, and the reflection window is a region on the substrate; and wherein, when the light emitted by the optical engine is irradiated to the region and reflected, the reflected light enters the design window of the diffraction display system.

2. The diffraction display system according to claim 1, wherein a surface of a last device of the optical engine constitutes the light emergent surface of the optical engine, and the reflection window is formed by the collection of intersection points between a line connecting any point of a desired reflection imaging position of the light emergent surface of the optical engine relative to the substrate to any point in the design window and the substrate.

3. The diffraction display system according to claim 1, wherein the optical engine is arranged in such a position as to enable the reflection window to completely deviate from the position of the diffraction projection screen.

4. The diffraction display system according to claim 1, wherein the diffraction display system is a HUD system mounted on a motor vehicle, and the substrate is a windshield.

5. The diffraction display system according to claim 1, wherein the optical engine also includes a directional projection device arranged on an optical path of the optical engine and used for changing the divergence of light beams emitted from points on the optical engine to make the same have a predetermined divergence angle and/or changing the direction of a center ray of the light beams to enable the light beams to have a specific spatial angular distribution.

6. The diffraction display system according to claim 5, wherein the directional projection device is configured in such a manner as to enable the light emitted from the optical engine to be only irradiated within the range of the diffraction projection screen.

7. The diffraction display system according to claim 5, wherein the directional projection device is a transmission-type device having a substantially plane-shaped substrate and is configured in such a manner as to enable the center rays of the light beams emitted therefrom and corresponding to each pixel to deviate from a direction perpendicular to the substrate.

8. The diffraction display system according to claim 5, wherein the image modulator modulates the light emitted by the coherent light source to obtain a light spatial distribution corresponding to the target image;
the optical engine also includes a light diffusing device receiving the light from the coherent light source and forming an area light source to enable the light beams emitted from the optical engine and corresponding to each pixel to be divergent; and
the directional projection device is arranged downstream of the light diffusing device and upstream of the image modulator along the optical path of the optical engine to limit the divergence angles of the light beams emitted from the optical engine and corresponding to each pixel.

9. The diffraction display system according to claim 5, wherein the directional projection device includes at least one of a lens, a diaphragm and a concave mirror.

10. The diffraction display system according to claim 5, wherein the image modulator modulates the light emitted by the coherent light source to obtain a light spatial distribution corresponding to the target image;
the optical engine also includes a light diffusing device for diffusing the light to enable light beams emitted from the optical engine and corresponding to each pixel to be divergent; and
the directional projection device is arranged downstream of the optical diffusing device and the image modulator along the optical path of the optical engine to limit a divergence angles of the light beams emitted from the optical engine and corresponding to each pixel.

11. The diffraction display system according to claim 10, wherein the light diffusing device is arranged downstream of the image modulator along the optical path of the optical engine.

12. The diffraction display system according to claim 8, wherein the light diffusing device is integrated with the directional projection device.

13. The diffraction display system according to claim 10, wherein the light diffusing device is arranged upstream of the image modulator along the optical path of the optical engine.

14. The diffraction display system according to claim 5, wherein the directional projection device includes at least one of a diaphragm array, a micro prism array, a micro lens array, a grating, a CGH, a HOE and a DOE.

15. The diffraction display system according to claim 5, wherein the image modulator modulates the light emitted by the coherent light source to obtain a light spatial distribution corresponding to the target image; and
the directional projection device receives and diffuses approximately parallel light beams corresponding to each pixel to make the same to have a specific divergent spatial angular distribution.

16. The diffraction display system according to claim 15, wherein the image modulator includes a scanning galvanometer.

17. The diffraction display system according to claim 16, wherein the directional projection device is a micro mirror array, a reflection-type grating or a reflection-type DOE arranged downstream of the scanning galvanometer along the optical path.

18. The diffraction display system according to claim 15, wherein the image modulator is an LCD, an LCOS or a DMD, and the optical engine further includes a collimating beam expander arranged between the coherent light source and the image modulator.

19. The diffraction display system according to claim 15, wherein the directional projection device includes at least one of a micro prism array, a micro lens array, a micro mirror array, a grating, a CGH, a HOE and a DOE.

20. The diffraction display system according to claim 8, wherein the diffraction projection screen diffracts the light from each pixel of the optical engine to form parallel or approximately parallel imaging beams, and the projection directions of the imaging beams corresponding to different pixels are different from each other.

21. A directional projection-based diffraction display system, comprising:
a substrate;
at least two diffraction projection screens, each comprising a diffractive optical device arranged at different positions on the substrate; and
a single optical engine, comprising a coherent light source and a single image modulator, and used for projecting to the diffraction projection screens light carrying information of a target image, thereby displaying a virtual image of the target image by the diffraction of the diffraction projection screen,
wherein the single optical engine also includes a directional projection device arranged on an optical path of the optical engine and used for changing a direction of at least one portion of the light such that the target images corresponding to different diffraction projection screens are only projected onto the corresponding diffraction projection screens respectively.

22. The diffraction display system according to claim 21, wherein the diffraction display system has a design window, and the at least two diffraction projection screens both project light beams formed by the diffraction to the design window.

23. The diffraction display system according to claim 21, wherein the directional projection device has a substantially plane-shaped substrate, and is configured to have subregions in the same number as the diffraction projection screens, each of the subregions has a different deflection effect on the direction of light irradiated thereon, so as to project the light to a corresponding diffraction projection screen.

24. The diffraction display system according to claim 23, wherein the directional projection device is also configured to limit a divergence angle of the light beams emitted from the optical engine and corresponding to each pixel.

25. The diffraction display system according to claim 21, wherein the directional projection device includes at least one of a diaphragm array, a micro mirror array, a micro prism array, a micro lens array, a grating, a CGH, a HOE and a DOE.

26. A directional projection-based diffraction display system, comprising:
a substrate;
a diffraction projection screen, comprising a diffractive optical device arranged on substantially the entire surface of the substrate; and
an optical engine, comprising a coherent light source and an image modulator, and used for projecting to the diffraction projection screen light carrying information of a target image, thereby projecting and displaying the target image by the diffraction of the diffraction projection screen,
wherein the optical engine also comprises a directional projection device arranged on an optical path of the optical engine to change the direction of the light such that light beams corresponding to each pixel of the target image are only projected onto local regions on the diffraction projection screen, and light beams corresponding to adjacent pixels are projected onto regions partially overlapped with each other on the diffraction projection screen, and the light beams corresponding to different pixels are projected onto different regions on the diffraction projection screen in an arrangement order of the pixels.

27. The diffraction display system according to claim 26, wherein the maximum field angle of the diffraction projection screen relative to the optical engine is greater than 120°.

28. The diffraction display system according to claim 26, wherein the diffraction projection screen diffracts the light from each pixel of the optical engine to form parallel or approximately parallel imaging beams, and the projection directions of the imaging beams corresponding to different pixels are different from each other.

29. The diffraction display system according to claim 26, wherein the diffraction display system is a HUD system mounted on a motor vehicle, and the substrate is a windshield;
and the local region onto which the light beams emitted by the optical engine and corresponding to each pixel of the target image are projected on the diffraction projection screen has an area greater than 10 cm×10 cm.

30. The diffraction display system according to claim 26, wherein the directional projection device limits a divergence angle of the light beams emitted from the optical engine and corresponding to each pixel.

31. The diffraction display system according to claim 26, wherein the directional projection device is a transmission-type device having a substantially plane-shaped substrate, and is configured in such a manner as to enable a center ray of the light beams emitted therefrom to deviate from a direction perpendicular to the substrate.

32. The diffraction display system according to claim 26, wherein the directional projection device includes at least one of a diaphragm array, a micro mirror array, a micro prism array, a micro lens array, a grating, a CGH, a HOE, and a DOE.
